(19) United States
(12) Patent Application Publication
(10) Pub. No.: US 2009/0095932 A1
(43) Pub. Date: Apr. 16, 2009

(54) Knife Gate Valve

(76) Inventors: James Leblanc, Lac La Biche (CA); Nancy Leblanc, Lac la Biche (CA)

Correspondence Address: FROST BROWN TODD, LLC, 2200 PNC CENTER, 201 E. FIFTH STREET, CINCINNATI, OH, 45202, US

(21) Appl. No.: 12/298,019

(22) PCT Filed: Apr. 20, 2007
(86) PCT No.: PCT/CA2007/000666

§ 371 Date: Nov. 3, 2008

(30) Foreign Application Priority Data
Apr. 21, 2006 (CA) 2,543,718

(51) Int. Cl. F16K 3/00

(52) U.S. Cl. 251/326

(57) ABSTRACT

A gate valve apparatus includes an inlet side panel, and outlet side panel defining a ring recess on its inner face. The panels are fastened together and the valve gate moves between the panels. A seat ring defines a seat ring aperture and is positioned in the ring recess and oriented such that fluid pushing on the front face of the gate seals the gate against the seat ring. Removable ring fasteners countersunk below the inner surface of the seat ring extend into the outlet side panel. Removable inlet and outlet wear rings are positioned in the corresponding inlet and outlet passages, and the inner end of the outlet wear ring extends into the seat ring aperture to cover the fastener heads. The inlet and outlet wear rings have an inside diameter equal to an inside diameter of the inlet and outlet conduits.

### BACKGROUND

A knife gate valve is a mechanical device used to regulate fluid flow, and is particularly suited to slurry transportation conduits that are heavy with rock, sand, or other inclusions that lead to wear, especially whenever the conduit makes a change in diameter which increases destructive flow turbulence. The knife gate has a beveled edge that aids closing of the valve by “slicing” through thick slurry. A one way gate valve is designed to be used where the conduit flow is in one direction only. Typically a valve body has flanges on each side thereof for attaching the valve to the inlet conduit on one side and the outlet conduit on the opposite side, and the gate moves up and down in the body to open or close the valve.

When the gate is closed, the pressure of the fluid from the inlet conduit exerts a force on the front side of the gate that pushes the gate against a seat ring on the back side of the gate. In slurry conduits the seat ring is typically a hard surfaced metal ring, such that the knife gate and the seat ring form a metal to metal seal to stop the fluid flow.

However, a positive seal is impossible to achieve once the seating surface becomes compromised through pitting, scoring, chipping, etc. At present the remedies available to the valve user are to replace the entire valve body or have the valve bodies retrofit with replaceable, hard faced wear and seat rings. An outlet wear and seat ring is inserted in the valve body from the outlet side, and the inner end of the outlet wear ring can provide an added replacement seat ring. The wear and seat ring has a hard, abrasion resistant coating applied where in contact with the fluid to protect the inside of the valve body from the destructive action of the slurry flowing through the body. The primary use is in heavy industrial transportation pipelines where the medium is extremely abrasive, corrosive, or may contain abrasive materials (such as sand, rock, diamond, etc.)

The inner end has a face that seats against the gate when the gate is closed and aids in sealing the valve when the original seat ring has become damaged. These wear and seat rings can be replaced as required. Since it is desirable to keep the inside diameter and flow area through the valve as close to the conduit flow area as possible, the wear ring radial thickness is less than the width of the original sealing face. For example in a 25 inch diameter conduit, the sealing face on the inner end of the wear and sea ring will generally be no greater than ½″, where the original valve body would have 1″ or more face to seat the valve gate. This reduced seating area reduces the wear capacity of the valve, since a lesser amount of surface scarring will result in valve leakage.

A similar inlet wear ring is inserted in the valve body from the inlet side. The inlet wear ring has a flange on the outer end such that when the flange contacts the body, the inner end is located near the gate.

The wear and seat rings do reduce the inside diameter of the passage and the flow area through the valve body, resulting in increased velocity of the fluid medium and amplified turbulence, and the resulting increased wear in the valve components and a corresponding reduction in service life.

### SUMMARY OF THE INVENTION

It is an object of the present invention to provide a knife gate valve that overcomes problems in the prior art.

The present invention provides a gate valve apparatus for controlling fluid flow from an inlet conduit through the valve apparatus to an outlet conduit. The apparatus comprises an inlet side panel adapted for connection to the inlet conduit and defining an inlet passage, and an outlet side panel adapted for connection to the outlet conduit and defining an outlet passage, and defining a ring recess on an inner face thereof that is concentric with the outlet passage. Removable panel fasteners are operative to fasten the inlet and outlet side panels together such that a gate chamber is formed between the side panels and such that the inlet and outlet passages are substantially aligned. A gate is operative to move in the gate chamber from an open position adjacent to the inlet and outlet passages to a closed position blocking the inlet and outlet passages. A seat ring has an inner surface defining a seat ring aperture and is positioned in the ring recess with a seating face oriented substantially parallel to a rear face of the gate such that a fluid exerting pressure on a front face of the gate pushes the rear face of the gate against the seating face to seal the outlet passage and stop fluid flow. Removable ring fasteners extend substantially radially from the inner surface of the seat ring through the seat ring and into the outlet side panel to fasten the seat ring to the outlet side panel. Heads of the ring fasteners are countersunk below the inner surface of the seat ring. A removable inlet wear ring is positioned in the inlet passage, and a removable outlet wear ring is positioned in the outlet passage. The inner end of the outlet wear ring is configured to extend into the seat ring aperture and cover the heads of the ring fasteners. The inlet and outlet wear rings have an inside diameter substantially equal to an inside diameter of the inlet and outlet conduits.

A knife gate valve utilizes a sliding bevelled gate positioned between two aligned conduits. In operation it is either fully opened or fully closed, and the apparatus of the present invention creates a passage through the valve that when completely open nearly approximates the flow area of the fluid conduit in which it is used. Having done this, there should be little to no change in the flow rate or turbulence of the transported medium. This will minimize the damaging potential of abrasive inclusions in the medium, improving the service life of the valve. The hard-faced wear rings are manufactured from material matching the conduit diametrical dimensions, therefore there is little to no loss in flow area through the valve.

The invention provides a valve body with increased wear resistant properties, while maintaining functionality and ease of maintenance. By using hard-faced, replaceable wear components, the service life of the valve is greatly increased. Additionally, a bolted body assembly is utilized, rather than a welded body, so that any component can be replaced readily.

The seat ring of the invention has a seating face with a width sufficient to provide a good seal, and the seat ring is held in place within the valve body with removable fasteners, such as capscrews, that are then isolated from the fluid medium by the wear ring.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a partial cut-away side view of an embodiment of the valve apparatus of the present invention;

FIG. 2 is a sectional side view of the embodiment of FIG. 1;

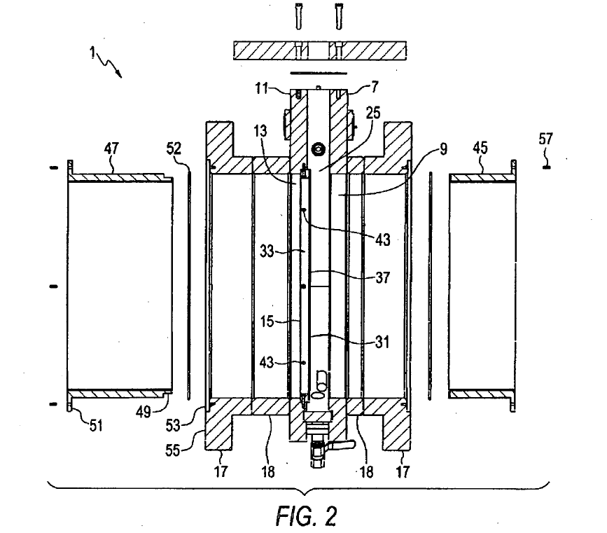

FIG. 3 is an enlarged sectional side view of a lower portion of the embodiment of FIG. 1;

FIG. 4 is an exploded perspective view of the embodiment of FIG. 1.

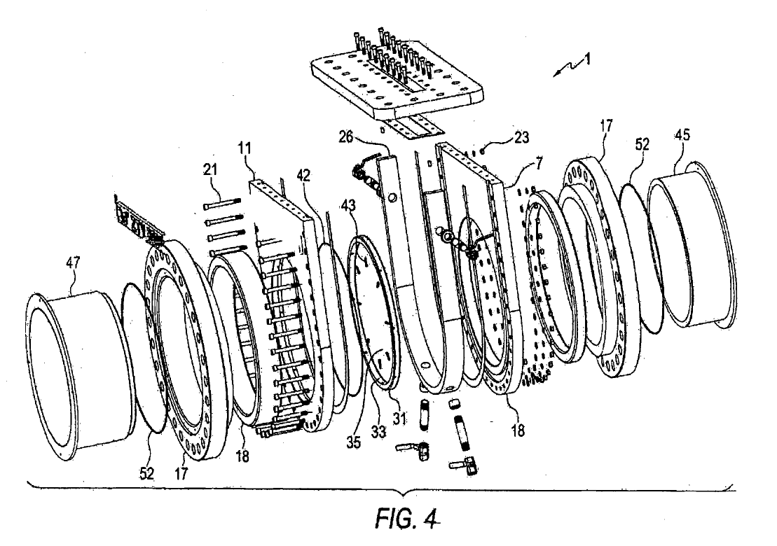

### DETAILED DESCRIPTION OF THE ILLUSTRATED EMBODIMENTS

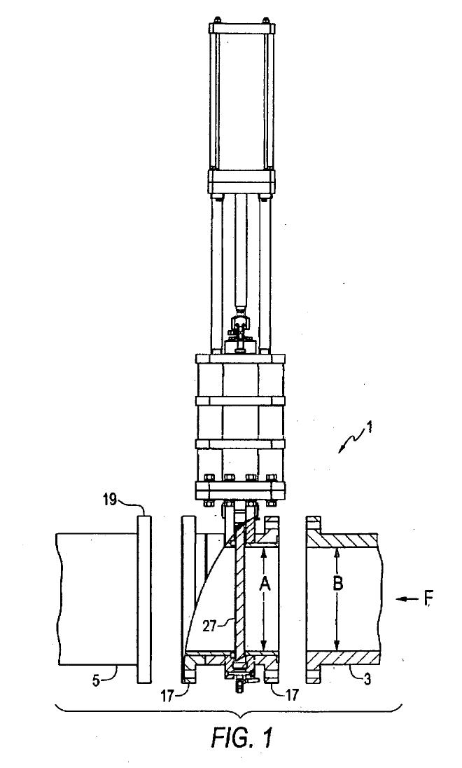

FIG. 1 illustrates a partial cut-away side view of an embodiment of a gate valve apparatus 1 of the present invention for controlling fluid flow from an inlet conduit 3 through the valve apparatus 1 to an outlet conduit 5. A fluid, for example a slurry, flows through the conduits 3, 5 in direction F. The apparatus 1 comprises an inlet side panel 7 adapted for connection to the inlet conduit 3 and defining an inlet passage 9, and an outlet side panel 11 adapted for connection to the outlet conduit 5 and defining an outlet passage 13. The outlet side panel also defines a ring recess 15 on an inner face thereof that is concentric with the outlet passage 13.

In the illustrated apparatus 1 side panels 7, 11 are adapted for connection to the conduits 3, 5 by providing a valve flange 17 attached to side panels 7, 11 with spacers 18 as desired for any particular application. The valve flanges 17 are configured for connection to corresponding conduit flanges 19 on the corresponding inlet and outlet conduits 3, 5. The inlet and outlet passages 9, 13 extend through the spacers 18 and valve flanges 17. It is contemplated that other known means for attachment could be used as well.

Removable panel fasteners, illustrated as panel bolts 21 and corresponding nuts 23, are operative to fasten the inlet and outlet side panels 7, 11 together such that a gate chamber 25 is formed between the side panels 7, 11 and such that the inlet and outlet passages 9, 13 are substantially aligned. In the illustrated apparatus 1, the gate chamber 25 is formed by fastening a spacer 26 between the side panels 7, 11.

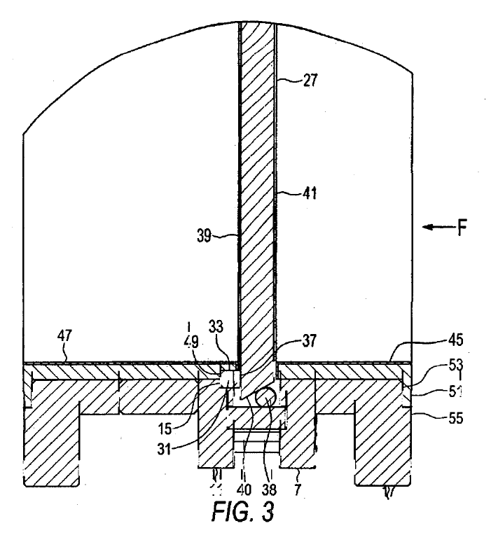

A gate 27 is operative to move in the gate chamber 25 from an open position adjacent to the inlet and outlet passages 9, 13 to a closed position blocking the inlet and outlet passages 9, 13. The closed position is illustrated in FIGS. 1 and 3.

A seat ring 31 has an inner surface 33 defining a seat ring aperture 35 and positioned in the ring recess 15 with a seating face 37 oriented substantially parallel to a rear face 39 of the gate 27 such that a fluid exerting pressure on a front face 41 of the gate 27 pushes the rear face 39 of the gate 27 against the seating face 37 to seal the outlet passage 13 and stop fluid flow. In the illustrated apparatus 1 a cylindrical crush rod 38 bears against the beveled lower edge 40 of the gate 27 to help force the rear face 39 of the gate 27 against the seating face 37 of the seat ring 31. An o-ring 42 seals the seat ring 31 to the outlet side panel 11. For abrasive slurry applications the seat ring 31 is made from a hardened metal material and forms a metal to metal seal with the metal gate 27.

Removable ring fasteners, illustrated as capscrews 43, extend substantially radially from the inner surface 33 of the seat ring 31 through the seat ring 31 and thread into holes in the outlet side panel 11 to fasten the seat ring 31 to the outlet side panel 11. The heads of the capscrews 43 are countersunk below the inner surface 33 of the seat ring 31.

A removable inlet wear ring 45 is positioned in the inlet passage 9, and a removable outlet wear ring 47 is positioned in the outlet passage 13. The wear rings 45, 47 are made of a hardened material to protect the valve components from wear caused by abrasive slurry flowing through the apparatus 1.

The inner end of the outlet wear ring 47 is configured to extend into the seat ring aperture 35 and cover the heads of the capscrews 43 fastening the seat ring 31 to the outlet side panel 11. Although it is contemplated that other configurations could be used as well, in the illustrated configuration the seat ring 31 extends somewhat into the outlet passage 13. In order for the outlet wear ring to be fully inserted inside the inner surface 33 of the seat ring 31, the outer surface of the inner end of the outlet wear ring 47 therefore defines a groove 49 and the seat ring 31 is located in the groove 49 such that the inner surface 33 of the seat ring 31 is covered by the outlet wear ring 47.

A ring flange 51 is attached to the outer ends of the inlet and the outlet wear rings 45, 47. The ring flange 51 is located in a flange groove 53 in a face of the corresponding valve flange 17 such that an outer face 55 of the valve flange 17 is substantially flat. An o-ring 52 seals the ring flanges 51 to the valve flanges 17. With the ring flanges 51 in the flange grooves 53, the inner ends of the wear rings 45, 47 are in proximity to the gate chamber 25. Screws 57 through the ring flanges 51 secure the wear rings 45, 47 to the valve flanges 17.

The apparatus 1 is configured such that the inlet and outlet wear rings 45, 47 have an inside diameter A that is substantially equal to the inside diameter B of the inlet and outlet conduits 3, 5. Thus when the gate 27 is moved to the open position, the inside diameter and thus the flow area through the valve apparatus 1 is substantially the same as that through the conduits 3, 5 with the result that the destructive turbulence caused by flow restrictions is substantially avoided.

The wear rings 45, 47 can be removed and replaced as required. Similarly the seat ring 31 can be removed and replaced by removing the panel bolts 21, and the capscrews 43. Advantageously in the illustrated valve apparatus 1 the seating face 37 is removed somewhat from the flow path of the fluid, and so wear resulting from the flow of abrasive fluid is reduced.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A gate valve apparatus for controlling fluid flow from an inlet conduit through the valve apparatus to an outlet conduit, the apparatus comprising:
an inlet side panel adapted for connection to the inlet conduit and defining an inlet passage;
an outlet side panel adapted for connection to the outlet conduit and defining an outlet passage, and defining a ring recess on an inner face thereof that is concentric with the outlet passage;
removable panel fasteners operative to fasten the inlet and outlet side panels together such that a gate chamber is formed between the side panels and such that the inlet and outlet passages are substantially aligned;
a gate operative to move in the gate chamber from an open position adjacent to the inlet and outlet passages to a closed position blocking the inlet and outlet passages;
a seat ring having an inner surface defining a seat ring aperture and positioned in the ring recess with a seating face oriented substantially parallel to a rear face of the gate such that a fluid exerting pressure on a front face of the gate pushes the rear face of the gate against the seating face to seal the outlet passage and stop fluid flow;
removable ring fasteners extending substantially radially from the inner surface of the seat ring through the seat ring and into the outlet side panel to fasten the seat ring to the outlet side panel wherein heads of the ring fasteners are countersunk below the inner surface of the seat ring;
a removable inlet wear ring in the inlet passage;
a removable outlet wear ring in the outlet passage, wherein an inner end of the outlet wear ring is configured to extend into the seat ring aperture and cover the heads of the ring fasteners; and
wherein the inlet and outlet wear rings have an inside diameter substantially equal to an inside diameter of the inlet and outlet conduits.

2. The apparatus of claim 1 wherein the gate chamber is formed by fastening a spacer between the side panels.

3. Claim 1 wherein the seat ring extends into the outlet passage, and wherein an outer surface of the inner end of the outlet wear ring defines a groove and the seat ring is located in the groove such that the inner surface of the seat ring is covered by the outlet wear ring.

4. The apparatus of claim 1 comprising a valve flange attached to one of the outlet side panel and the inlet side panel, the valve flange adapted for connection to a corresponding conduit flange on a corresponding one of the outlet conduit and the inlet conduit.

5. The apparatus of claim 4 comprising a ring flange attached to an outer end of one of the outlet wear ring and the inlet wear ring, wherein the ring flange is located in a flange groove in a face of the corresponding valve flange such that an outer face of the valve flange is substantially flat.
